(19) United States
(12) Patent Application Publication
(10) Pub. No.: US 2018/0232781 A1
(43) Pub. Date: Aug. 16, 2018

(54) ADVERTISEMENT SYSTEM AND ADVERTISEMENT METHOD USING 3D MODEL

(71) Applicant: Je Hyung KIM, Seoul (KR)

(72) Inventor: Je Hyung KIM, Seoul (KR)

(21) Appl. No.: 15/751,723

(22) PCT Filed: Aug. 5, 2016
(86) PCT No.: PCT/KR2016/008650

§ 371 Date: Feb. 9, 2018

(30) Foreign Application Priority Data
Aug. 10, 2015 (KR) 10-2015-0112458

(51) Int. Cl. G06Q 30/02; G06F 17/30; G06T 19/20

(52) U.S. Cl. CPC G06Q 30/0276; G06T 2219/2016; G06T 19/20; G06F 17/30864

(57) ABSTRACT

An advertising system and an advertising method using a 3D model. The advertising system includes a contents manager configured to provide contents where a 3D model is disposed on a background on which an advertisement is represented in at least a partial area; a 3D model analysis unit configured to analyze the 3D model, and generate an analysis information about the 3D model; an advertisement providing unit configured to provide an advertisement information by using at least one of a background type information for the background and the analysis information about the 3D model; and a background providing unit configured to provide the background including the advertisement information for representing the advertisement, to the contents manager.

### TECHNICAL FIELD

Various embodiments generally relate to an advertising system and an advertising method, and, more particularly, to an advertising system and an advertising method which use a 3D model, dispose the 3D model on a background and provide contents that implement an advertisement related with the 3D model, through the background.

### BACKGROUND ART

Recently, three-dimensional (hereinafter referred to “3D”) photographing technologies or 3D imaging technologies have been developed variously, and various objects such as a person or an animal may be represented as a 3D model. The 3D model may be provided as contents that may be represented by a computer graphic tool using a 3D image file.

Contents that provide a 3D model as described above are advantageous in that a user may feel a stereoscopic effect and may feel more a sense of reality than contents providing a 2D model. Therefore, a 3D model may be utilized in various fields that may use the above advantage.

Currently, a 3D model is limited in its range of use to the level of being registered to be shaped by a 3D printer in an online system.

Thus, it is necessary to develop a technology capable of increasing the utilization of a 3D model and triggering various e-commerce transactions using a 3D model.

### DISCLOSURE

### Technical Problem

Various embodiments are directed to an advertising system and an advertising method, capable of providing contents in which a 3D model is disposed on a 2D background or a 3D background and representing an advertisement related with the 3D model, through the contents.

### Technical Solution

In an embodiment, an advertising system may include: a contents manager configured to provide contents where a 3D model is disposed on a background on which an advertisement is represented in a partial area; a 3D model analysis unit configured to analyze the 3D model provided by a user, and generate an analysis information about the 3D model; an advertisement providing unit configured to generate and provide an advertisement information by using the analysis information about the 3D model; and a background providing unit configured to represent, by a template, an advertisement corresponding to the advertisement information, on the background selected by the user, and provide the background on which the advertisement is represented in the partial area, to the contents manager, wherein the contents manager allows the user to select the 3D model and the background, requests analysis of the selected 3D model to the 3D model analysis unit, and generates and provides the contents where the 3D model selected by the user is disposed on the background which is provided from the background providing unit and is represented with the advertisement in correspondence to the analysis-requested 3D model.

In an embodiment, an advertising method may include: a first act of analyzing a 3D model and generating an analysis information about the 3D model, by a 3D model analysis unit; a second act of generating and providing an advertisement information by using the analysis information about the 3D model, by an advertisement providing unit; a third act of providing a background on which an advertisement corresponding to the advertisement information is represented by a template, by a background providing unit; and a fourth act of providing contents where the 3D model is disposed on the background on which the advertisement is represented, by a contents manager.

### Advantageous Effects

According to the embodiments, since a 3D model uploaded by a user may be shared by being disposed on a background, the utilization of the 3D model may be increased, and since an advertisement related with the 3D model is represented through the background, an advertisement effect may be improved.

### BRIEF DESCRIPTION OF DRAWINGS

FIG. 1 is a block diagram illustrating a representation of an example of an advertising system using a 3D model in accordance with an embodiment.

FIG. 2 is a diagram illustrating a representation of an example of contents provided by the advertising system using a 3D model in accordance with the embodiment.

FIG. 3 is a diagram illustrating a representation of another example of contents provided by the advertising system using a 3D model in accordance with the embodiment.

FIG. 4 is a representation of an example of a flow chart to assist in the explanation of an advertising method using a 3D model in accordance with an embodiment.

FIG. 5 is a representation of an example of a flow chart to assist in the explanation of the 3D model analyzing method of FIG. 4.

FIG. 6 is a representation of an example of a flow chart to assist in the explanation of the advertisement providing method of FIG. 4.

### MODE FOR DISCLOSURE

Hereinafter, embodiments of the present disclosure will be described in detail with reference to the accompanying drawings. The terms used herein and in the claims shall not be construed by being limited to general or dictionary meanings and shall be interpreted based on the meanings and concepts corresponding to technical aspects of the present disclosure.

Embodiments described herein and configurations illustrated in the drawings are preferred embodiments of the present disclosure, and, because they do not represent all of the technical features of the present disclosure, there may be various equivalents and modifications that can be made thereto at the time of the present application.

The present disclosure provides contents in which a 3D model implemented as a 3D image is disposed on a 2D background or a 3D background, and the contents may be represented through various media such as a viewer program that is executable on a computer or a mobile terminal or a web page that is linked with a viewer. Representation of the contents may be implemented in a variety of ways by a creator.

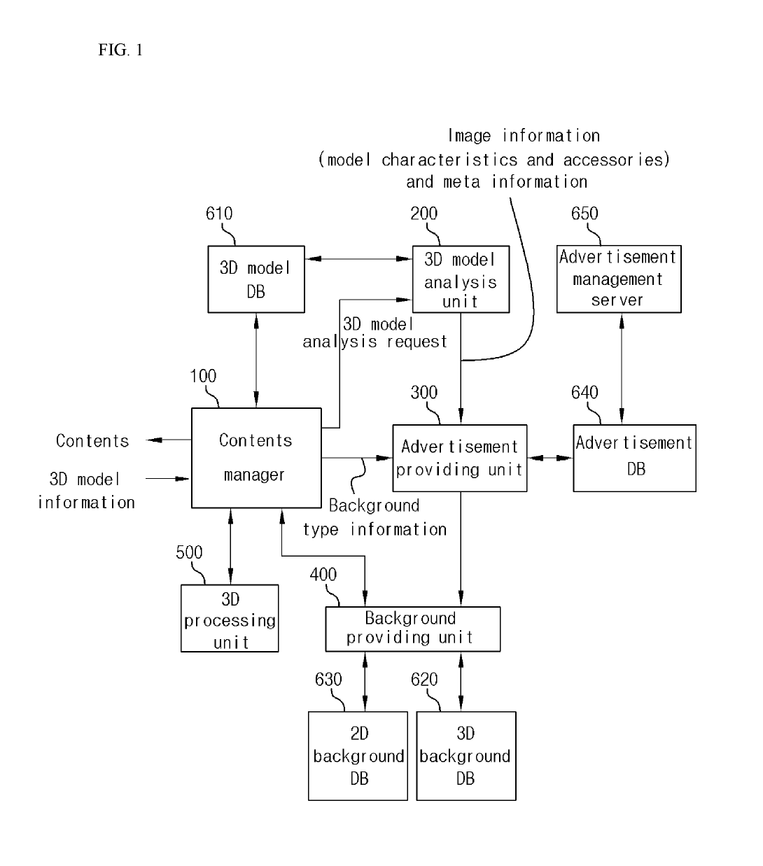

The present disclosure may be embodied as shown in FIG. 1 to provide the above-described contents. Referring to FIG. 1, an advertising system using a 3D model in accordance with an embodiment may include a contents manager 100, a 3D model analysis unit 200, an advertisement providing unit 300 and a background providing unit 400.

The advertising system using a 3D model in accordance with the embodiment may be provided with a 3D model information which a user provides through the Internet, and may provide the contents such that the user may use the contents through a user terminal.

The Internet is nothing but a mere example of a medium which connects the user and the advertising system using a 3D model in accordance with the embodiment, and various wired or wireless media may be used in the implementation of the present disclosure.

The user means a person who accesses the advertising system using a 3D model in accordance with the embodiment, registers a 3D model and inquires contents.

The user terminal means a computer or a mobile terminal used by the user. The user terminal may mean all devices capable of accessing the advertising system using a 3D model in accordance with the embodiment through the Internet. The user terminal is installed with an application program capable of playing a 3D model and contents, such as a web page or a flash window. The advertising system using a 3D model in accordance with the embodiment may be a network including a plurality of servers.

The contents manager 100 provides contents in which a 3D model is disposed on a background where an advertisement is represented in at least a partial area. The background means a background for a 3D model, in which an advertisement to be described later is represented in a partial area, and may be a 3D background or a 2D background.

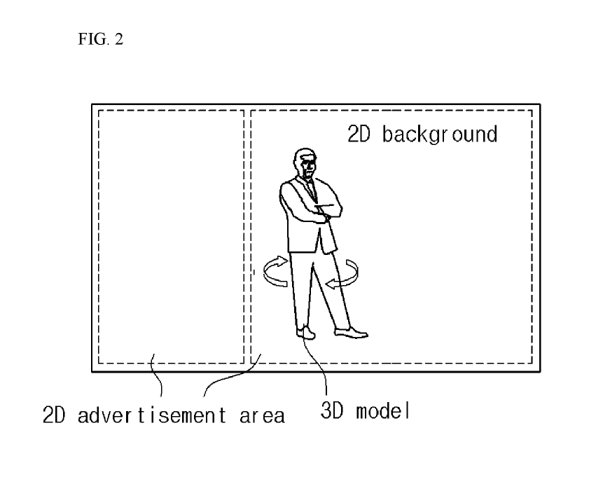

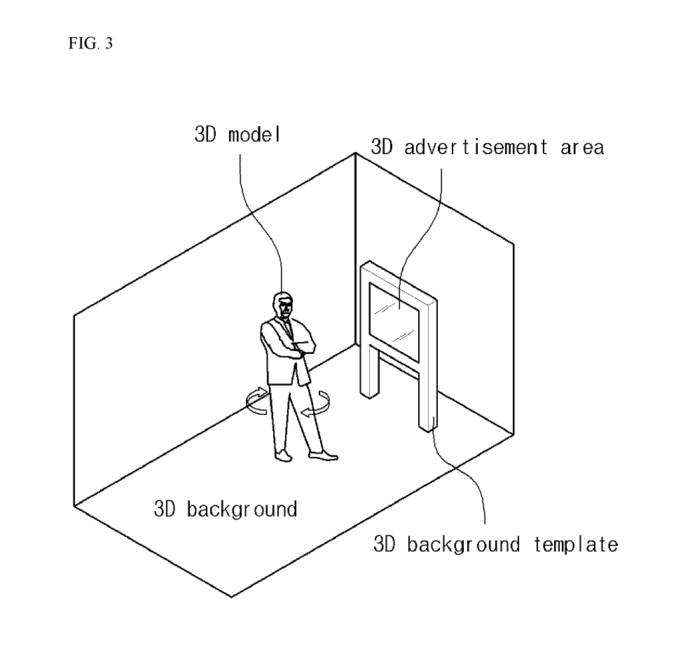

That is to say, the contents manager 100 provides the contents as shown in FIGS. 2 and 3 to the user. FIG. 2 illustrates an example in which a 3D model is disposed on a 2D background. One or a plurality of 2D advertisement areas may be set in a 2D background. The 2D advertisement areas may be defined by a template. FIG. 3 illustrates an example in which a 3D model is disposed on a 3D background. A 3D background template is disposed on the 3D background, and a 3D advertising area is formed on the 3D background template. The 3D background may be a space that three-dimensionally represents various places, for example, such as a beach, a city, a plain and a valley. The 2D background may be a screen or a certain character or image that two-dimensionally represents various places or objects. Detailed descriptions for FIGS. 2 and 3 will be made later.

The contents manager 100 allows the user to select a 3D model and a background for representing contents as shown in FIG. 2 or 3, requests the analysis of the selected 3D model to the 3D model analysis unit 200, generates contents in which the 3D model selected by the user is disposed on the background on which the advertisement provided from the background providing unit 400 in correspondence to the analysis-requested 3D model is represented, and provides the generated contents.

The user may register his/her 3D model through the contents manager 100, and the contents manager 100 manages the registered 3D model by using a 3D model database 610.

The 3D model may mean 3D data generated through a rendering process after photographing a certain object or 3D data generated by using a 3D modeling tool, etc. The 3D model may be understood as a 3D image file.

Not only the 3D image file includes the image of the 3D model, but also the additional informations of the corresponding 3D model, such as the photographing location, photographing time, sex, nationality, etc. of the corresponding 3D model may be included in a meta information. The meta information may include a usual basic information on the characteristics (file size, etc.) of the 3D image file and the above-described additional informations.

An advertisement means all promotional contents capable of being represented on a 2D background or a 3D background. In the embodiment of the present disclosure, an advertisement provided as a result of 3D model analysis is represented. An advertisement may be implemented as a 3D or 2D object depending on its kind or attribute. An advertisement means one that is stored in an advertisement database 640 through an advertisement management server 650 by an advertiser or a system manager.

When the user selects the 3D model and the background, the contents manager 100 requests the analysis of the 3D model to the 3D model analysis unit 200 to generate an advertisement for the 3D model.

Further, the contents manager 100 may provide a background type information on the background selected by the user, to the advertisement providing unit 300.

The 3D model analysis request by the contents manager 100 may be determined to be performed at various points of time such as when the user uploads the 3D model, immediately after selection or when another user inquires the 3D model.

The background type information may be secured from the background providing unit 400 when the user selects the background, and is an information which is provided by the contents manager 100 to the advertisement providing unit 300 such that an advertisement appropriate to be represented on the selected background may be selected.

In detail, the background type information may include the number of advertisements that may be included in the background, the positions of the advertisements, an information on advertisements allowed to be selected, an information on the atmosphere of the background, an information on the types of templates for the advertisements and an information for determining whether it is a 2D background or a 3D background. When uploading the 3D model, the user may select one background that is considered to be appropriate for the 3D model, among various backgrounds provided by the contents manager 100 through using the background providing unit 400. If the user does not select a background, the contents manager 100 may provide a random background provided from the background providing unit 400 or a predetermined background.

The contents manager 100 may provide a 3D rotation function corresponding to a result of performing 3D computation on the 3D model, the advertisement and the background, to the user, in link with a 3D processing unit 500. Therefore, the user may view the 3D model, the advertisement and the background with various viewing angles, through using the function provided by the contents manager 100. The 3D processing unit 500 may provide a zoom-in/zoom-out function for the 3D model, the advertisement and the background.

The 3D rotation function or the zoom-in/zoom-out function provided by the 3D processing unit 500 may provide a method for the user to effectively view the 3D model and the background and check the advertisement.

The 3D model analysis unit 200 analyzes the 3D model in response to the analysis request of the contents manager 100, and provides an analysis information on the 3D model.

The 3D model analysis unit 200 fetches an information on the 3D model, that is, a 3D image file, from the 3D model database 610 for the analysis of the 3D model.

The 3D model analysis unit 200 performs analysis about the 3D model by using the 3D image file for the 3D model and the meta information defined in the 3D image file.

In detail, the 3D model analysis unit 200 analyzes, by using the 3D image of the 3D model, an image information including at least one of the model characteristic information of the 3D model and an information on subordinates subordinate to the 3D model, analyzes the meta information defined in the 3D model, and generates the image information and the meta information as an analysis information.

The 3D model analysis unit 200 may extract at least one of shape, appearance and color of at least a part included in the 3D model on the 3D image, as the model characteristic information, and the model characteristic information may include at least one of kind, sex, skin color, hair style, body figure, height and pose for the 3D model. The kind of the 3D model means a kind such as person, animal or article, the sex means to distinguish man and woman, the skin color means to distinguish the skin color of the 3D model, the hair style means to distinguish the length or contour of hair, the body figure means to distinguish the degrees of slimness and fatness, and the pose means to distinguish the posture of the 3D model.

The 3D model analysis unit 200 extracts at least one of character, figure, shape, appearance and color distinguished from the 3D model as the subordinate information, and the subordinate information may include at least one of the kind, trademark, product, model and design of a subordinate. The kind of the subordinate means to distinguish goods or animal, the trademark means the brand of an object represented in text or pattern, the product means to distinguish a kind such as a bag, a hat, a garment or a shoe, and the model means to distinguish the model name of a product, and the design means to distinguish a shape and a color.

In order to distinguish a subordinate from the 3D model, an algorithm capable of perceiving a human's skin and recognizing the human separately from an article or an algorithm capable of performing image segmentation by considering the surface of the 3D model as a set of 2D images and recognizing the 3D model through clustering the set of 2D images may be used. Also, it is possible to recognize the characters, figures, patterns and the likes represented on the surface of the 3D model and consider them as a single trademark for a subordinate.

The 3D model analysis unit 200 extracts at least one of a photographing position, a photographing location, a photographing time, a photographer and the name of a subject for the 3D model, as the meta information. The meta information may be understood as arbitrarily defining an information difficult to extract from an image, in the 3D image file.

The advertisement providing unit 300 generates an advertisement information by using the analysis information of the 3D model analysis unit 200 for the 3D model and provides the advertisement information to the background providing unit 400. To this end, the advertisement providing unit 300 may receive the background type information from the contents manager 100 and may receive the analysis information including the meta information and the image information from the 3D model analysis unit 200.

The advertisement database 640 is configured for the advertisement information search of the advertisement providing unit 300. The advertisement database 640 stores advertisement informations classified into one or more categories based on image informations or meta informations, and the advertisement providing unit 300 may extract an advertisement information matching the image information or the meta information included in the analysis information, from the advertisement database 640, and provide the extracted advertisement information.

The advertisement informations of the advertisement database 640 may be managed using the advertisement management server 650. The advertisement management server 650 may be operated as a separate server that may be connected with the advertising system of the present disclosure through a medium for communication such as the Internet, and may be used by the manager of the advertising system of the present disclosure or an advertiser to register an advertisement information. The advertisement management server 650 may be installed with a separate application for registering an advertisement information in the advertisement database 640.

An advertisement information may include data in various formats, such as a text, a 2D or 3D image and a moving picture, for advertising a certain trademark or product.

An advertisement information may be limited in size or format so as to be applied to each of various templates disposed to represent advertisements on backgrounds.

Therefore, the advertisement providing unit 300 may search an advertisement information appropriate for the background type information and provide the searched advertisement information.

For example, the advertisement providing unit 300 may analyze the background type information and determine which one of 3D and 2D advertisements is to be searched, may specify the category of an advertisement information according to the atmosphere of the corresponding background, and may select a search target depending on a position or a feature capable of disposing an advertisement on the corresponding background.

In the case where the background type information is restricted to use only a specific advertisement, the advertisement providing unit 300 may exclude the analysis information and search an advertisement by using only the background type information.

The advertisement providing unit 300 may search only a predetermined number of advertisement informations defined in the background type information.

The advertisement providing unit 300 may select the range of advertisement informations to be searched in correspondence to the analysis information including the image information and the meta information. The advertisement providing unit 300 may select the range of advertisement informations to be searched through informations such as sex, skin color and height of the corresponding 3D model, by using the model characteristic information included in the image information.

Moreover, the advertisement providing unit 300 may select the range of advertisement informations to be searched by using the garment of the corresponding 3D model or the kind or trademark of an accessory, through using the subordinate information included in the image information.

If the advertisement providing unit 300 finishes a search for advertisement informations, it may provide advertisement informations in order of high weight to the background providing unit 400, among searched advertisement informations.

A weight may be set variously for each advertisement information, depending on the degree of match with the image information or the meta information, the priority set in advance for each advertisement, the value designated by the background type information, and so forth. Also, a weight may be randomly adjusted by the manager of the advertising system using a 3D model or an advertiser.

The background providing unit 400 provides the background including an advertisement information for representing an advertisement, to the contents manager 100.

The background providing unit 400 checks the background selected by the user when the user uploads the 3D model by using the contents manager 100, and is provided with a background information from a 3D background database 620 or a 2D background database 630 depending on whether the selected background is a 3D background or a 2D background.

The background providing unit 400 combines the advertisement information received from the advertisement providing unit 300 with the background information provided from the background database 620 or 630. Then, the background providing unit 400 combines the background information and the advertisement information, and provides the background on which an advertisement is represented in at least a partial area, to the contents manager 100.

The background information as an information which a 2D or 3D background has may include not only a background type information but also a 2D image or a 3D image for the corresponding background, and may also include various template informations to be combined with each background.

The background providing unit 400 provides a background information in which an advertisement corresponding to the advertisement information is disposed, to the contents manager 100.

The contents manager 100 generates the contents as shown in FIG. 2 or 3 by disposing the selected 3D model in the background information provided from the background providing unit 400, and provides the contents to the user.

The user may check the contents provided as shown in FIG. 2 or 3, by using the 3D rotation function or the zoom-in/zoom-out function provided by the contents manager 100.

The user may view the 3D model at various points of time by 3D-rotating or zooming in/zooming out the 3D model. When the user views the 3D model, the advertisement represented on the 2D or 3D background may be exposed to the user. In correspondence to that the user 3D-rotates or zooms in/zooms out the 3D model, the 3D background and the advertisement of an advertisement template may also be rotated or zoomed in/zoomed out.

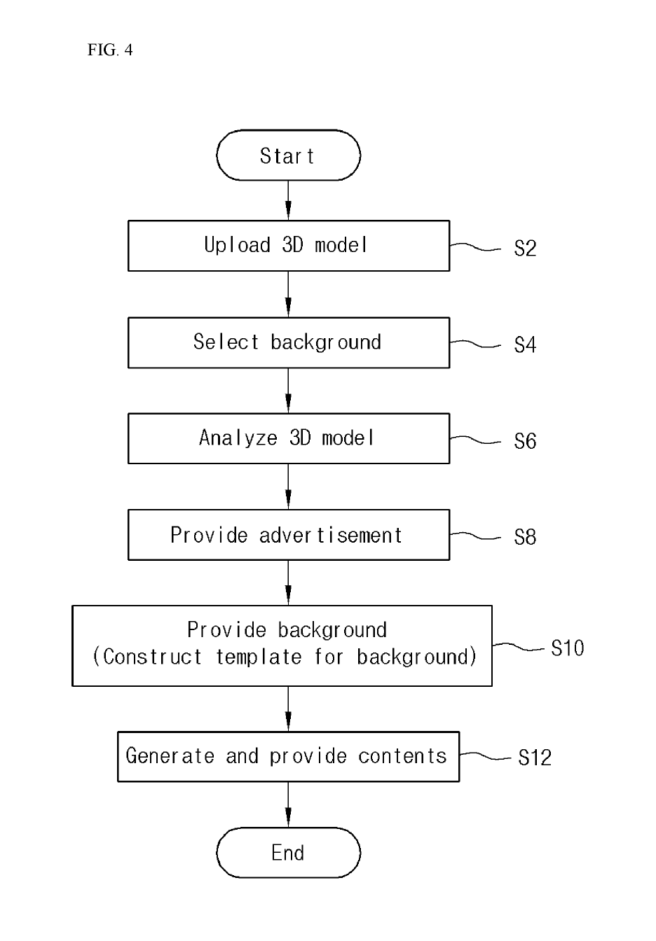

An advertising method of the advertising system using a 3D model in accordance with the embodiment of the present disclosure, configured as mentioned above, will be described below with reference to FIGS. 4 to 6.

A user uploads a 3D model (S2) and selects a background (S4), through the contents manager 100.

The contents manager 100 requests analysis about the 3D model to the 3D model analysis unit 200 after the 3D model is uploaded and the background is selected, and in correspondence to that, the 3D model analysis unit 200 performs the analysis of the 3D model by using the 3D image file fetched from the 3D model database 610 and corresponding to the 3D model (S6).

If the analysis about the 3D model is completed by the 3D model analysis unit 200 and an analysis information including an image information and a meta information is provided to the advertisement providing unit 300, the advertisement providing unit 300 provides an advertisement by referring to the background type information provided from the contents manager 100 and using the analysis information (S8).

Thereafter, if an advertisement information is provided to the background providing unit 400 from the advertisement providing unit 300, the background providing unit 400 constructs a template for the background and provides the background on which the advertisement to be represented through the template is represented using the advertisement information, to the contents manager 100 (S10).

If the background is provided from the background providing unit 400 as described above, the contents manager 100 generates contents by combining the background and the 3D model and provides the contents to the user (S12).

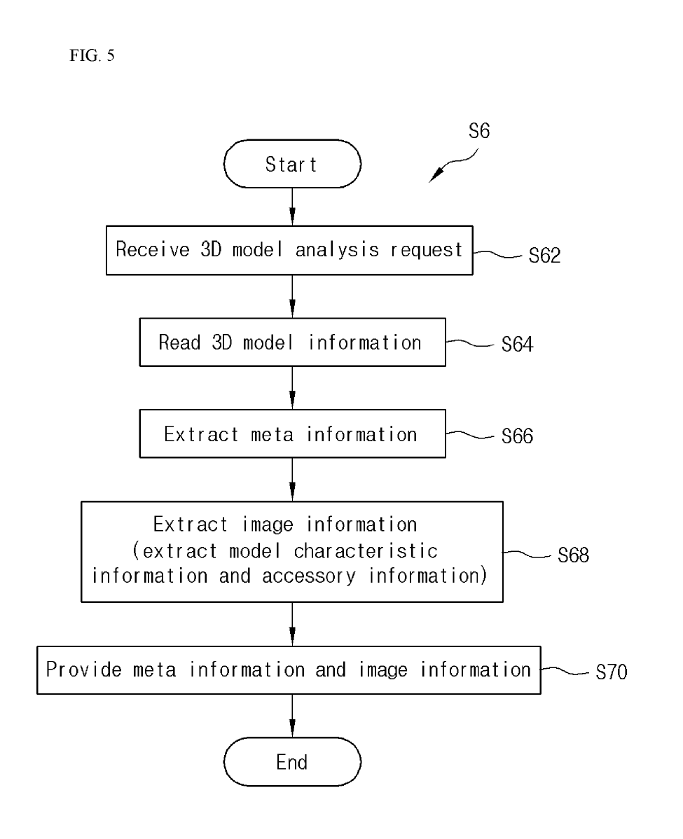

FIG. 5 is a representation of an example of a flow chart to assist in the explanation of the 3D model analysis process S6 of FIG. 4.

The 3D model analysis unit 200 receives a 3D model analysis request from the contents manager 100 (S62), and in correspondence to that, reads in the information of the 3D model from the 3D model database 610 (S64). Thereafter, the 3D model analysis unit 200 extracts the meta information (S66) and extracts the image information (S68), by analyzing the information of the 3D model, and provides the meta information and the image information to the advertisement providing unit 300 (S70).

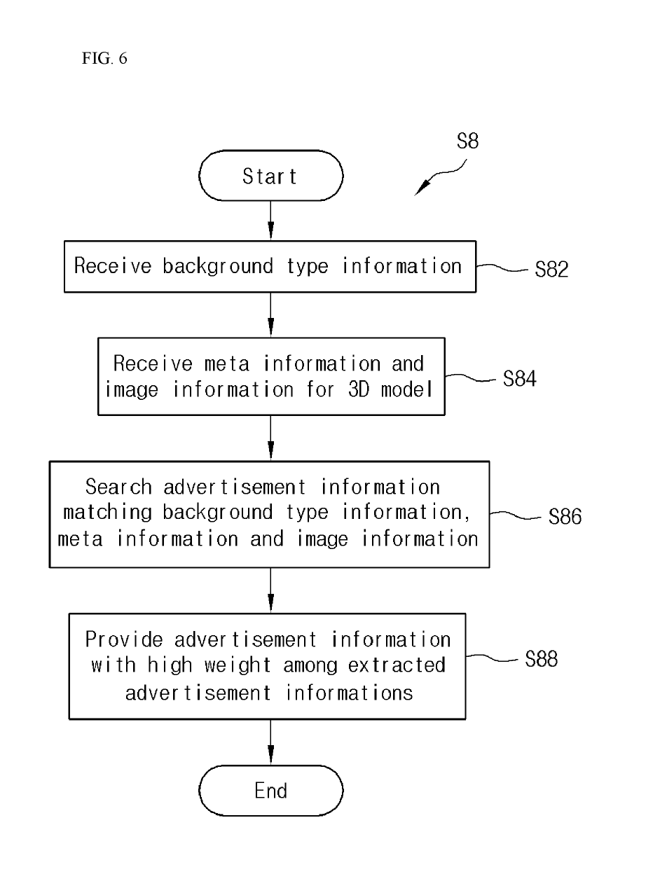

FIG. 6 is a representation of an example of a flow chart to assist in the explanation of the advertisement providing process S8 of FIG. 4.

The advertisement providing unit 300 receives the background type information from the contents manager 100 (S82), and receives the meta information and the image information about the 3D model from the 3D model analysis unit 200 (S84). Thereafter, the advertisement providing unit 300 searches an advertisement information matching the received background type information, meta information and image information (S86). The advertisement providing unit 300 provides an advertisement information with a high weight among searched advertisement informations, to the background providing unit 400 (S88). As is apparent from the above descriptions, according to the embodiments, since a 3D model uploaded by a user may be shared by being disposed on a background, the utilization of the 3D model may be increased, and since an advertisement related with the 3D model is represented through the background, an advertisement effect may be improved.

While various embodiments have been described above, it will be understood to those skilled in the art that the embodiments described are by way of example only. Accordingly, the disclosure described herein should not be limited based on the described embodiments.

1. An advertising system comprising:
a contents manager configured to provide contents where a 3D model is disposed on a background on which an advertisement is represented in a partial area;
a 3D model analysis unit configured to analyze the 3D model provided by a user, and generate an analysis information about the 3D model;
an advertisement providing unit configured to generate and provide an advertisement information by using the analysis information about the 3D model; and
a background providing unit configured to represent, by a template, an advertisement corresponding to the advertisement information, on the background selected by the user, and provide the background on which the advertisement is represented in the partial area, to the contents manager,
wherein the contents manager allows the user to select the 3D model and the background, requests analysis of the selected 3D model to the 3D model analysis unit, and generates and provides the contents where the 3D model selected by the user is disposed on the background which is provided from the background providing unit and is represented with the advertisement in correspondence to the analysis-requested 3D model.

2. The advertising system according to claim 1, further comprising:
a 3D processing unit configured to perform 3D computation for 3D rotation of at least one of the 3D model, the background and the advertisement,
the 3D processing unit performs the 3D rotation in correspondence to the user's choice.

3. The advertising system according to claim 1, wherein the 3D model analysis unit performs analysis about the 3D model by using a 3D image file for the 3D model and a meta information defined in the 3D image file.

4. The advertising system according to claim 1, wherein the 3D model analysis unit analyzes, by using a 3D image of the 3D model, an image information including at least one of a model characteristic information of the 3D model and an information on subordinates subordinate to the 3D model, analyzes the meta information defined in the 3D model, and generates the image information and the meta information as the analysis information.

5. The advertising system according to claim 4, wherein the 3D model analysis unit extracts at least one of shape, appearance and color of at least a part included in the 3D model on the 3D image, as the model characteristic information.

6. The advertising system according to claim 5, wherein the model characteristic information includes at least one of kind, sex, skin color, hair style, body figure, height and pose for the 3D model.

7. The advertising system according to claim 4, wherein the 3D model analysis unit extracts at least one of character, figure, shape, appearance and color distinguished from the 3D model, as the subordinate information.

8. The advertising system according to claim 7, wherein the subordinate information includes at least one of kind, trademark, product, model and design of a subordinate.

9. The advertising system according to claim 3, wherein the 3D model analysis unit extracts at least one of a photographing position, a photographing location, a photographing time, a photographer and a name of a subject for the 3D model, as the meta information.

10. The advertising system according to claim 1, further comprising:
an advertisement database configured to store the advertisement information classified into at least one category based on the image information and the meta information,
wherein the advertisement providing unit extracts and provides the advertisement information matching the image information or the meta information included in the analysis information, from the advertisement database.

11. The advertising system according to claim 1, wherein the background providing unit provides any one of a 3D background and a 2D background capable of including the template, as the background.

12. The advertising system according to claim 1,
wherein the contents manager provides a background type information for the selected background, to the advertisement providing unit, and
wherein the advertisement providing unit provides the advertisement information which is to be represented on the selected background, by using the background type information.

13. An advertising method comprising:
a first act of analyzing a 3D model and generating an analysis information about the 3D model, by a 3D model analysis unit;
a second act of generating and providing an advertisement information by using the analysis information about the 3D model, by an advertisement providing unit;
a third act of providing a background on which an advertisement corresponding to the advertisement information is represented by a template, by a background providing unit; and
a fourth act of providing contents where the 3D model is disposed on the background on which the advertisement is represented, by a contents manager.

14. The advertising method according to claim 13, wherein, in the first act, analysis of the 3D model is performed by using a 3D image file for the 3D model and a meta information defined in the 3D image file.

15. The advertising method according to claim 13, wherein the first act comprises:
analyzing, by using a 3D image of the 3D model, an image information including at least one of a model characteristic information of the 3D model including at least one of shape, appearance and color of at least a part included in the 3D model and an information on subordinates subordinate to the 3D model and including at least one of character, figure, the shape, the appearance and the color distinguished from the 3D model;
analyzing the meta information defined in the 3D model; and
generating the image information and the meta information as the analysis information.

16. The advertising method according to claim 15, wherein the model characteristic information includes at least one of kind, sex, skin color, hair style, body figure, height and pose for the 3D model.

17. The advertising method according to claim 15, wherein the subordinate information includes at least one of kind, trademark, product, model and design of a subordinate.

18. The advertising method according to claim 14, wherein the meta information includes at least one of a photographing position, a photographing location, a photographing time, a photographer and a name of a subject for the 3D model.

19. The advertising method according to claim 13, wherein the second act generates and provides the advertisement information which is to be represented on the background, by using a type information for the background.
